(19) United States
(12) Patent Application Publication
(10) Pub. No.: US 2025/0126697 A1
(43) Pub. Date: Apr. 17, 2025

(54) EXTREME ULTRAVIOLET LIGHT GENERATION APPARATUS AND ELECTRONIC DEVICE MANUFACTURING METHOD

(71) Applicant: Gigaphoton Inc., Tochigi (JP)

(72) Inventors: Yoshiyuki HONDA, Oyama-shi (JP); Hirokazu HOSODA, Oyama-shi (JP); Tomoyoshi TOIDA, Oyama-shi (JP)

(73) Assignee: Gigaphoton Inc., Tochigi (JP)

(21) Appl. No.: 18/882,498

(22) Filed: Sep. 11, 2024

(30) Foreign Application Priority Data
Oct. 12, 2023 (JP) 2023-177076

(51) Int. Cl. H05G 2/00; H01S 3/00

(52) U.S. Cl. CPC H05G 2/0082; H01S 3/005; H05G 2/0035

(57) ABSTRACT

An extreme ultraviolet light generation apparatus includes a chamber, a target supply unit configured to supply a target into the chamber, a prepulse laser configured to generate a diffusion target having a Gaussian distribution shape convex toward a travel direction of prepulse laser light by irradiating the target with the prepulse laser light, and a main pulse laser configured to generate extreme ultraviolet light by irradiating the diffusion target with main pulse laser light having an intensity distribution of a Gaussian distribution shape.

### CROSS-REFERENCE TO RELATED APPLICATIONS

The present application claims the benefit of Japanese Patent Application No. 2023-177076, filed on Oct. 12, 2023, the entire contents of which are hereby incorporated by reference.

### BACKGROUND

### 1. Technical Field

The present disclosure relates to an extreme ultraviolet light generation apparatus, and an electronic device manufacturing method.

### 2. Related Art

Recently, miniaturization of a transfer pattern in optical lithography of a semiconductor process has been rapidly proceeding along with miniaturization of the semiconductor process. In the next generation, microfabrication at 10 nm or less will be required. Therefore, it is expected to develop a semiconductor exposure apparatus that combines an apparatus for generating extreme ultraviolet (EUV) light having a wavelength of about 13 nm with a reduced projection reflection optical system.

As the EUV light generation apparatus, a laser produced plasma (LPP) type apparatus using plasma generated by irradiating a target substance with laser light has been developed.

### LIST OF DOCUMENTS

### Patent Documents

Patent Document 1: Japanese Patent Application Publication No. 2009-105006
Patent Document 2: US Patent Application Publication No. 2014/0264087
Patent Document 3: US Patent Application Publication No. 2012/0243566
Patent Document 4: U.S. Pat. No. 8,791,440

### SUMMARY

An extreme ultraviolet light generation apparatus according to an aspect of the present disclosure includes a chamber, a target supply unit configured to supply a target into the chamber, a prepulse laser configured to generate a diffusion target having a Gaussian distribution shape convex toward a travel direction of prepulse laser light by irradiating the target with the prepulse laser light, and a main pulse laser configured to generate extreme ultraviolet light by irradiating the diffusion target with main pulse laser light having an intensity distribution of a Gaussian distribution shape.

An electronic device manufacturing method according to an aspect of the present disclosure includes generating extreme ultraviolet light using an extreme ultraviolet light generation apparatus, outputting the extreme ultraviolet light to an exposure apparatus, and exposing a photosensitive substrate to the extreme ultraviolet light in the exposure apparatus to manufacture an electronic device. Here, the extreme ultraviolet light generation apparatus includes a chamber, a target supply unit configured to supply a target into the chamber, a prepulse laser configured to generate a diffusion target having a Gaussian distribution shape convex toward a travel direction of prepulse laser light by irradiating the target with the prepulse laser light, and a main pulse laser configured to generate the extreme ultraviolet light by irradiating the diffusion target with main pulse laser light having an intensity distribution of a Gaussian distribution shape.

An electronic device manufacturing method according to an aspect of the present disclosure includes inspecting a defect of a mask by irradiating the mask with extreme ultraviolet light generated by an extreme ultraviolet light generation apparatus, selecting a mask using a result of the inspection, and exposing and transferring a pattern formed on the selected mask onto a photosensitive substrate. Here, the extreme ultraviolet light generation apparatus includes a chamber, a target supply unit configured to supply a target into the chamber, a prepulse laser configured to generate a diffusion target having a Gaussian distribution shape convex toward a travel direction of prepulse laser light by irradiating the target with the prepulse laser light, and a main pulse laser configured to generate the extreme ultraviolet light by irradiating the diffusion target with main pulse laser light having an intensity distribution of a Gaussian distribution shape.

### BRIEF DESCRIPTION OF THE DRAWINGS

Embodiments of the present disclosure will be described below merely as examples with reference to the accompanying drawings.

FIG. 1 shows the configuration of an LPP-type EUV light generation system according to a comparative example.

FIG. 2 shows a state in which a target is irradiated with prepulse laser light in the comparative example.

FIG. 3 shows a state in which a diffusion target is irradiated with main pulse laser light in the comparative example.

FIG. 4 shows a center portion, which easily turns into plasma, and a peripheral portion, which does not easily turn into plasma, of the diffusion target in the comparative example.

FIG. 5 shows a state in which the target is irradiated with the prepulse laser light in an embodiment.

FIG. 6 shows a state in which the diffusion target is irradiated with the main pulse laser light in the embodiment.

FIG. 7 shows an intensity distribution of the main pulse laser light in the embodiment.

FIG. 8 shows the configuration of a device for measuring the diffusion target.

FIG. 9 is an image of the diffusion target imaged by an imaging unit in the comparative example.

FIG. 10 is an image obtained by binarization of FIG. 9.

FIG. 11 is a graph showing the number of pixels of dark spots at each position in the Y direction in FIG. 10.

FIG. 12 is an image of the diffusion target imaged by the imaging unit in the embodiment.

FIG. 13 is an image obtained by binarization of FIG. 12.

FIG. 14 is a graph showing the number of pixels of dark spots at each position in the Y direction in FIG. 13.

FIG. 15 is a graph showing the relationship between conversion efficiency and light intensities of the prepulse laser light and the main pulse laser light.

FIG. 16 is a graph showing intensity distributions of EUV light in the comparative example and the embodiment.

FIG. 17 schematically shows the configuration of an exposure apparatus connected to the EUV light generation system.

FIG. 18 schematically shows the configuration of an inspection apparatus connected to the EUV light generation system.

### DESCRIPTION OF EMBODIMENTS

### Contents

1. Comparative example
   1.1 Configuration
   1.2 Operation
   1.3 Problem of comparative example
2. EUV light generation apparatus 1 which generates diffusion target 27a having Gaussian distribution shape
   2.1 Irradiation conditions
   2.2 Shape of diffusion target 27a
   2.3 Intensity ranges of prepulse laser light 31p and main pulse laser light 31m
   2.4 Intensity distribution in accordance with EUV radiation angle A_{EUV}
   2.5 Residual debris after irradiation of main pulse laser light 31m
   2.6 Effect
3. Others
   3.1 Examples of EUV light utilization apparatus 6
   3.2 Supplement

Hereinafter, an embodiment of the present disclosure will be described in detail with reference to the drawings. The embodiment described below shows some examples of the present disclosure and do not limit the contents of the present disclosure. Also, all configurations and operation described in the embodiment are not necessarily essential as configurations and operation of the present disclosure. Here, the same components are denoted by the same reference numeral, and duplicate description thereof is omitted.

### 1. Comparative Example

### 1.1 Configuration

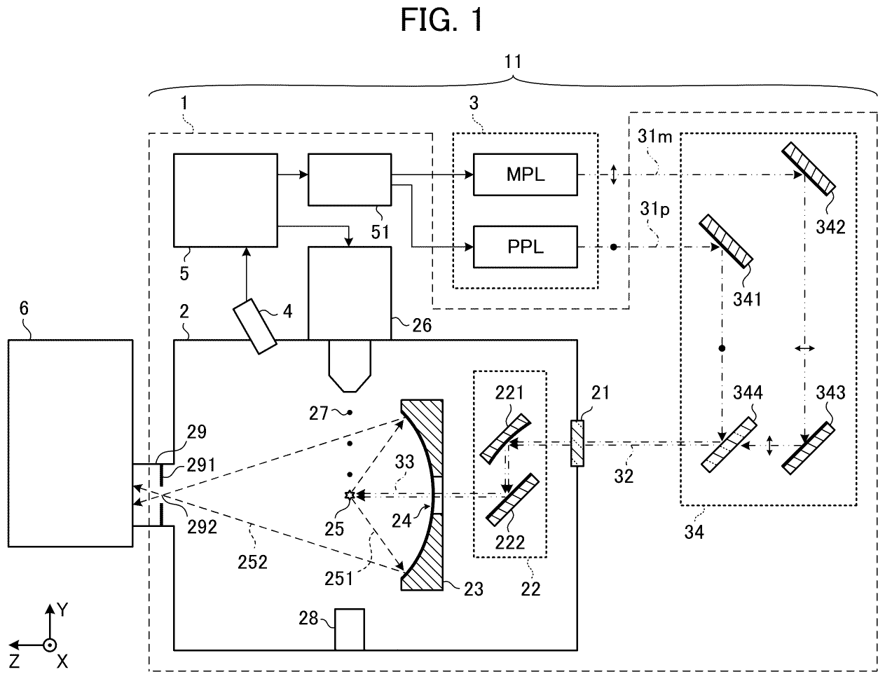

FIG. 1 shows the configuration of an LPP-type EUV light generation system 11 according to a comparative example. The comparative example of the present disclosure is an example recognized by the applicant as known only by the applicant, and is not a publicly known example admitted by the applicant. An EUV light generation apparatus 1 is used together with a laser device 3. In the present disclosure, a system including the EUV light generation apparatus 1 and the laser device 3 is referred to as the EUV light generation system 11. The laser device 3 includes a prepulse laser PPL and a main pulse laser MPL. The prepulse laser PPL outputs prepulse laser light 31p having a wavelength of 1 μm, and the main pulse laser MPL outputs main pulse laser light 31m having a wavelength of 1 μm. Each of the prepulse laser PPL and the main pulse laser MPL may be, for example, any of a neodymium-doped yttrium aluminum garnet (Nd:YAG) laser, an ytterbium-doped yttrium aluminum garnet (Yb:YAG) laser, and a neodymium-doped yttrium lithium fluoride (Nd:YLF) laser.

The EUV light generation apparatus 1 includes a chamber 2 and a target supply unit 26. The chamber 2 is a sealable container. The target supply unit 26 supplies a target 27 containing tin as a target substance into the chamber 2.

A through hole is formed in a wall of the chamber 2. The through hole is blocked by a window 21 and pulse laser light 32 output from the laser device 3 is transmitted through the window 21. An EUV light concentrating mirror 23 having a spheroidal reflection surface is arranged in the chamber 2. A multilayer reflective film in which molybdenum and silicon are alternately laminated is formed on the reflection surface. The EUV light concentrating mirror 23 has first and second focal points. The EUV light concentrating mirror 23 is arranged such that the first focal point is located in a plasma generation region 25 and the second focal point is located at an intermediate focal point 292. A through hole 24 is formed at the center of the EUV light concentrating mirror 23, and pulse laser light 33 passes through the through hole 24.

The EUV light generation apparatus 1 includes a processor 5, a delay circuit 51, a target sensor 4, and the like. The processor 5 is a processing device including a memory (not shown) and a central processing unit (CPU) (not shown). The processor 5 is specifically configured or programmed to perform various processes included in the present disclosure. The delay circuit 51 is configured to output first and second delay trigger signals obtained by delaying a trigger signal output from the processor 5. The first delay trigger signal is input to the prepulse laser PPL, and the second delay trigger signal is input to the main pulse laser MPL after the first delay trigger signal. The target sensor 4 detects at least one of the presence, trajectory, position, and velocity of the target 27. The target sensor 4 may have an imaging function.

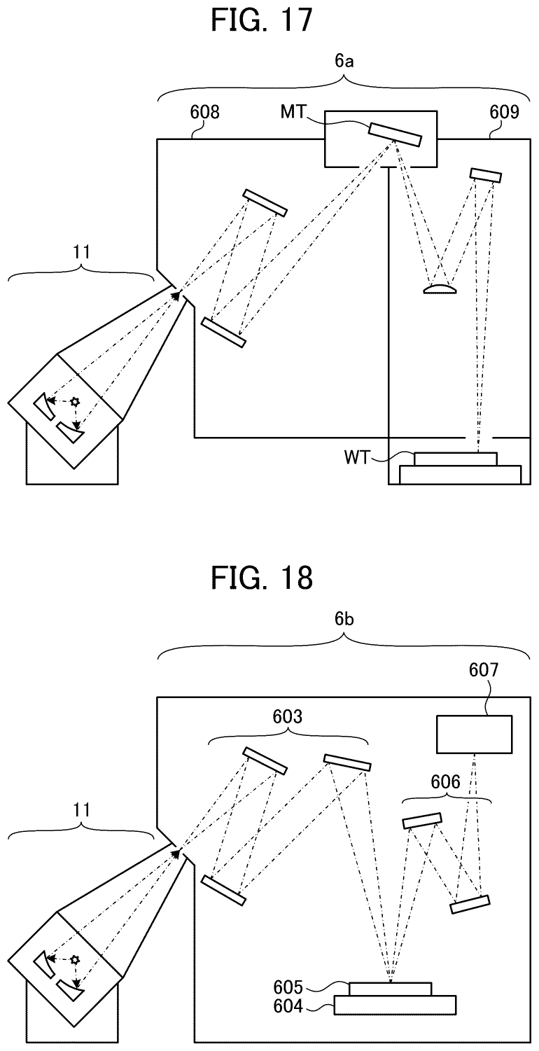

Further, the EUV light generation apparatus 1 includes a connection portion 29 providing communication between the internal space of the chamber 2 and the internal space of an EUV light utilization apparatus 6. The EUV light utilization apparatus 6 may be an exposure apparatus 6a shown in FIG. 17 or an inspection apparatus 6b shown in FIG. 18. A wall 291 in which an aperture is formed is arranged in the connection portion 29. The wall 291 is arranged such that the aperture is located at the second focal point of the EUV light concentrating mirror 23.

Further, the EUV light generation apparatus 1 includes a laser light transmission device 34, a laser light concentrating optical system 22, a target collection unit 28 for collecting the target 27, and the like. The laser light transmission device 34 includes optical elements such as high reflection mirrors 341 to 343 and a beam combiner 344, and actuators (not shown) for adjusting the position, posture, and the like of the optical elements. The beam combiner 344 is configured of, for example, a polarizing beam splitter. The laser light concentrating optical system 22 includes an off-axis paraboloidal concave mirror 221 and a high reflection mirror 222.

### 1.2 Operation

Operation of the EUV light generation system 11 will be described with reference to FIG. 1. The laser device 3 outputs the prepulse laser light 31p and the main pulse laser light 31m in this order in accordance with the first and second delay trigger signals output from the delay circuit 51. The prepulse laser light 31p includes a polarization component perpendicular to the paper surface, and the main pulse laser light 31m includes a polarization component parallel to the paper surface. The laser light transmission device 34 causes the prepulse laser light 31p and the main pulse laser light 31m to be incident respectively on opposite surfaces of the beam combiner 344 by the high reflection mirrors 341 to 343. The beam combiner 344 reflects one of the prepulse laser light 31p and the main pulse laser light 31m and transmits the other thereof, so that the optical path axes of the both substantially coincide with each other and are output from the laser light transmission device 34. The prepulse laser light 31p and the main pulse laser light 31m output from the laser light transmission device 34 are collectively referred to as the pulse laser light 32. The pulse laser light 32 is transmitted through the window 21 and enters the chamber 2. The pulse laser light 32 passes through the laser light concentrating optical system 22 and is concentrated on the plasma generation region 25 as the pulse laser light 33.

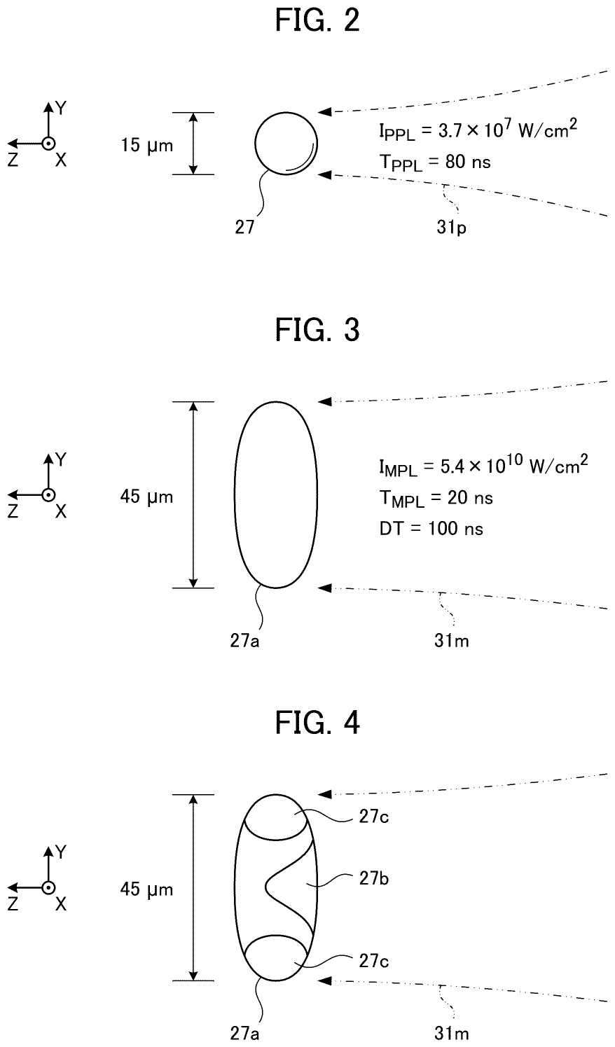

The target supply unit 26 outputs the droplet-shaped target 27 toward the plasma generation region 25 in the chamber 2. FIG. 2 shows a state in which the target 27 is irradiated with the prepulse laser light 31p in the comparative example. The diameter of the target 27 is, for example, 15 μm. The target 27 irradiated with the prepulse laser light 31p is diffused, and becomes a diffusion target 27a shown in FIG. 3. FIG. 3 shows a state in which the diffusion target 27a is irradiated with the main pulse laser light 31m in the comparative example. Since the density of the diffusion target 27a is lower than that of the droplet-shaped target 27, the energy of the main pulse laser light 31m can be efficiently applied to the diffusion target 27a.

At least a part of the diffusion target 27a irradiated with the main pulse laser light 31m is gasified, a part of the gasified target substance is turned into plasma, and radiation light 251 is radiated from the plasma (see FIG. 1). EUV light contained in the radiation light 251 is reflected by the EUV light concentrating mirror 23 with higher reflectance than light in other wavelength ranges. Reflection light 252 including the EUV light reflected by the EUV light concentrating mirror 23 is concentrated at the intermediate focal point 292 and output to the EUV light utilization apparatus 6. In the following description, the output direction of the EUV light is defined as the +Z direction, and the output direction of the target 27 is defined as the −Y direction. The +Z direction and the −Y direction are perpendicular to each other, and the directions perpendicular to both the +Z direction and the −Y direction are defined as the +X direction and the −X direction.

The processor 5 controls the entire EUV light generation system 11. The processor 5 processes a detection result of the target sensor 4. Based on the detection result of the target sensor 4, the processor 5 controls the output direction of the target 27, the timing of the trigger signal output to the delay circuit 51, and the like. Further, the processor 5 controls a delay time set in the delay circuit 51, the travel direction of the pulse laser light 32, the concentration position of the pulse laser light 33, and the like. The above-described various kinds of control are merely examples, and other control may be added as necessary.

### 1.3 Problem of Comparative Example

Irradiation conditions of the prepulse laser light 31p and the main pulse laser light 31m in the comparative example are as follows.
Light intensity I_{PPL} of the prepulse laser light 31p at an irradiation position of the target 27: 3.7×10⁷ W/cm²
A pulse width T_{PPL} of the prepulse laser light 31p: 80 ns
Light intensity I_{MPL} of the main pulse laser light 31m at an irradiation position of the diffusion target 27a: 5.4×10¹⁰ W/cm²
A pulse width T_{MPL} of the main pulse laser light 31m: 20 ns
Delay time DT from when the target 27 is irradiated with the prepulse laser light 31p to when the diffusion target 27a is irradiated with the main pulse laser light 31m: 100 ns

The pulse widths T_{PPL}, T_{MPL} are represented as full width at half maximum. The light intensities I_{PPL}, I_{MPL} correspond to I given by the following expression, where E is the pulse energy, T is the pulse width, and D is the focus diameter, that is, the total width of a part having an intensity equal to or more than 1/e² of the peak intensity at the irradiation position of the target 27 or the diffusion target 27a.

$$I = ( E / ( π ( D / {2}^{2} ) ) / T$$

The delay time DT is a time difference between peak times in the pulse time waveforms of the prepulse laser light 31p and the main pulse laser light 31m. The delay time DT is set in accordance with a required time from when the target 27 is irradiated with the prepulse laser light 31p to when the diffusion target 27a becomes a spheroid having a diameter equal to or less than the focus diameter (e.g., 45 μm) of the main pulse laser light 31m.

FIG. 4 shows a center portion 27b, which easily turns into plasma, and a peripheral portion 27c, which does not easily turn into plasma, of the diffusion target 27a in the comparative example. Since the main pulse laser light 31m has an intensity peak at the center of the optical path, a large energy is applied to the center portion 27b among the diffusion target 27a. However, even though many target substances are distributed in the peripheral portion 27c of the diffusion target 27a away from the center portion 27b, the peripheral portion 27c is not applied as much energy as the center portion 27b. Therefore, even if the energy of the entire main pulse laser light 31m is increased, the peripheral portion 27c may not be sufficiently turned into plasma.

With the irradiation conditions in the comparative example, the conversion efficiency CE from the energy of the laser light to the energy of the EUV light is 1.4%. Further improvement of the conversion efficiency CE is required.

### 2. EUV Light Generation Apparatus 1 which Generates Diffusion Target 27a Having Gaussian Distribution Shape

### 2.1 Irradiation Conditions

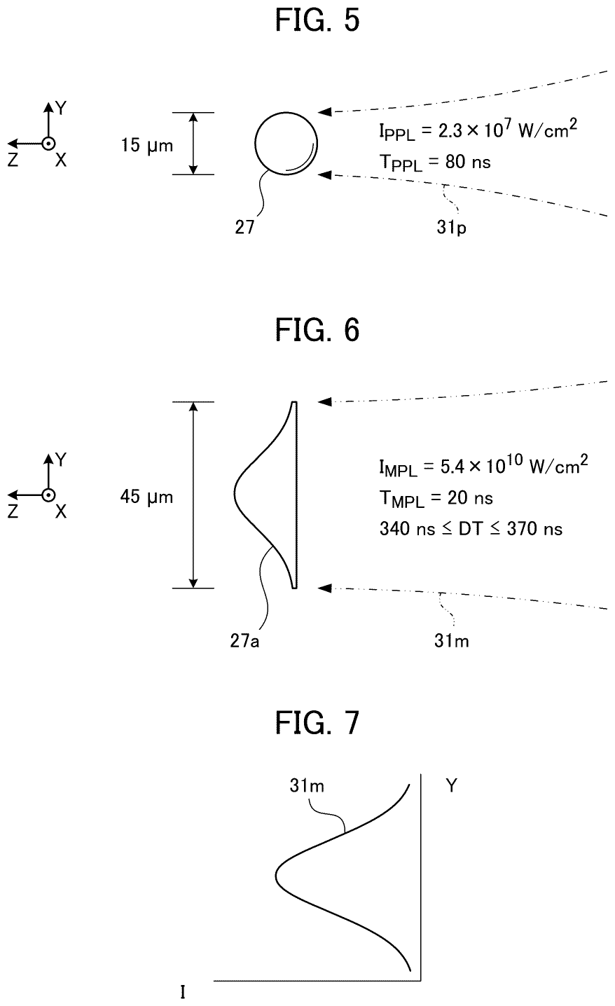

FIG. 5 shows a state in which the target 27 is irradiated with the prepulse laser light 31p in an embodiment. FIG. 6 shows a state in which the diffusion target 27a is irradiated with the main pulse laser light 31m in the embodiment. In the embodiment, the light intensity I_{PPL} of the prepulse laser light 31p is 2.3×10⁷ W/cm². As a result, as shown in FIG. 6, the diffusion target 27a convex toward the travel direction of the prepulse laser light 31p is generated. The configuration of the EUV light generation apparatus according to the embodiment is similar to that of the comparative example.

The delay time DT from when the target 27 is irradiated with the prepulse laser light 31p to when the diffusion target 27a is irradiated with the main pulse laser light 31m is preferably equal to or more than 100 ns and equal to or less than 400 ns, and more preferably equal to or more than 340 ns and equal to or less than 370 ns. In the embodiment, since the light intensity I_{PPL} of the prepulse laser light 31p is less than that in the comparative example, the required time from when the target 27 is irradiated with the prepulse laser light 31p to when the diameter of the diffusion target 27a becomes equal to or less than the focus diameter (e.g., 45 μm) of the main pulse laser light 31m is longer than that in the comparative example.

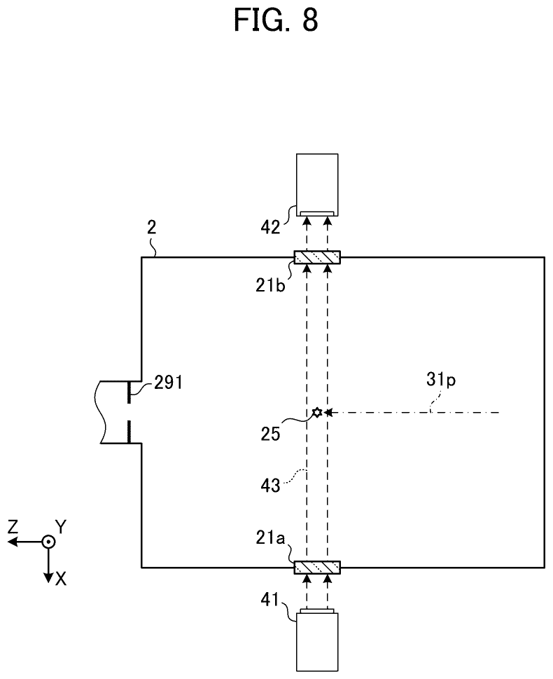

FIG. 7 shows an intensity distribution of the main pulse laser light 31m according to the embodiment. The intensity distribution of the main pulse laser light 31m has a Gaussian distribution shape. The focus diameter of the main pulse laser light 31m is preferably equal to or less than the size of the diffusion target 27a in a direction perpendicular to the Z direction, and is equal to or more than 30 μm and equal to or less than 100 μm depending on the size of the diffusion target 27a.

In other respects, the irradiation conditions in the embodiment are similar to the irradiation conditions in the comparative example. The pulse width T_{PPL} of the prepulse laser light 31p is not limited to 80 ns, and may be equal to or more than 60 ns and equal to or less than 100 ns. The pulse width T_{MPL} of the main pulse laser light 31m is not limited to 20 ns, and may be equal to or more than 10 ns and equal to or less than 30 ns.

### 2.2 Shape of Diffusion Target 27a

FIG. 8 shows the configuration of a device for measuring the diffusion target 27a. FIG. 8 corresponds to a view in which the inside of the chamber 2 is viewed in the −Y direction, which is the output direction of the target 27. In the chamber 2, two windows 21a, 21b are arranged with the plasma generation region 25 at which the diffusion target 27a is generated interposed therebetween. A white flashlight 41 and an imaging unit 42 are arranged outside the chamber 2 with the windows 21a, 21b interposed therebetween. Illustration of other components inside the chamber 2 is omitted.

At a timing at which the delay time DT elapses after the target 27 is irradiated with the prepulse laser light 31p, the white flashlight 41 generates a light beam 43 that perpendicularly intersects with the optical path axis of the prepulse laser light 31p in the plasma generation region 25. At this time, the main pulse laser light 31m is not radiated. A part of the light beam 43 passes through the diffusion target 27a and the periphery thereof and enters the imaging unit 42, and the imaging unit 42 images the shape of the diffusion target 27a. A pulse laser or a light emitting diode may be used in place of the white flashlight 41.

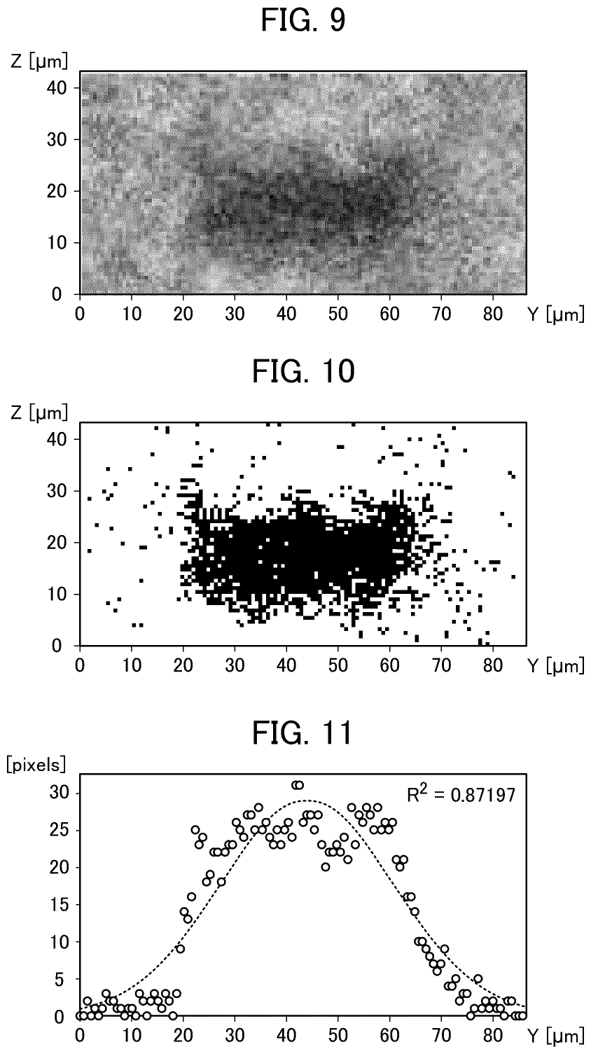

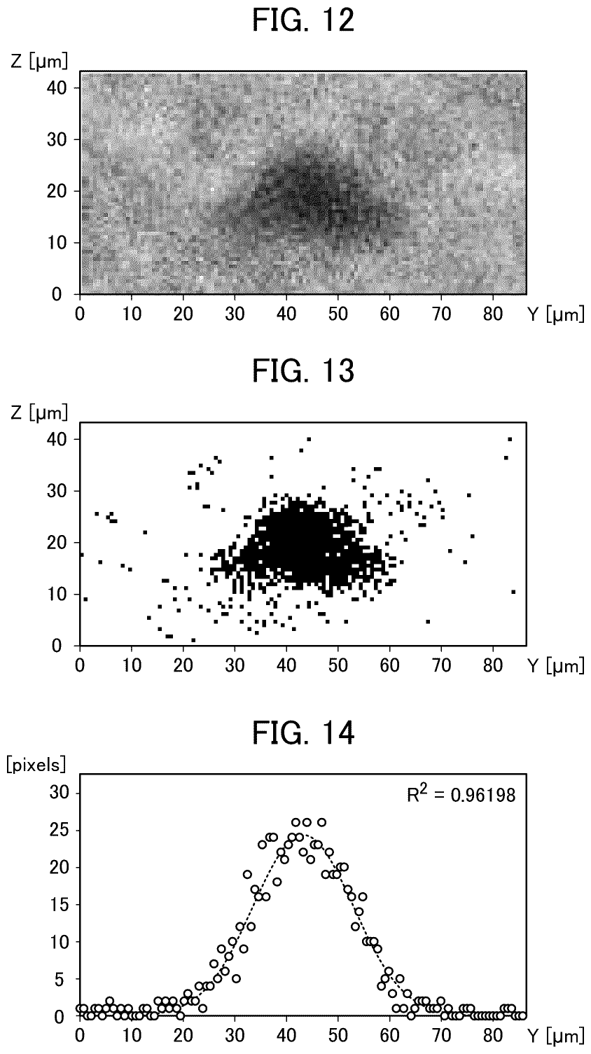

FIG. 9 shows an image of the diffusion target 27a imaged by the imaging unit 42 in the comparative example, and FIG. 12 shows an image of the diffusion target 27a imaged by the imaging unit 42 in the embodiment. Each of the images in FIGS. 9 and 12 corresponds to an image of a space of 86 μm in the Y direction and 43 μm in the Z direction in the vicinity of the plasma generation region 25. The +Z direction is the travel direction of the prepulse laser light 31p. The mist-like target substance contained in the diffusion target 27a scatters or absorbs a part of the light beam 43 generated by the white flashlight 41, and thus becomes a dark part in each image.

FIGS. 10 and 13 show images obtained by binarization of FIGS. 9 and 12, respectively. FIGS. 11 and 14 are graphs showing the number of pixels of dark spots at each position in the Y direction in FIGS. 10 and 13, respectively, where the horizontal axis represents the position in the Y direction and the vertical axis represents the number of pixels of dark spots.

In the embodiment, the number of dark spots is peaked in the vicinity of the position of Y=43 μm, and the number of dark spots decreases from the position of the peak toward the +Y direction and the −Y direction. When a Gaussian function indicated by a broken line was fitted as an approximate curve for the number of pixels of dark spots in FIG. 14, the determination coefficient R² of the number of pixels of dark spots with respect to the Gaussian function was 0.96198, and the distribution of the number of pixels of dark spots and the Gaussian distribution were similar to each other.

On the other hand, in the comparative example, the number of pixels of dark spots is distributed substantially uniformly in the space from the vicinity of the position of Y=20 μm to the vicinity of the position of Y=60 μm. When the Gaussian function indicated by a broken line was fitted as an approximate curve for the number of pixels of dark spots in FIG. 11, the determination coefficient R² of the number of pixels of dark spots with respect to the Gaussian function was 0.87197, and the distribution of the number of pixels of dark spots and the Gaussian distribution did not coincide with each other.

As described with reference to FIG. 7, the intensity distribution of the main pulse laser light 31m is a Gaussian distribution shape. The determination coefficient R² of the intensity distribution of the main pulse laser light 31m with respect to the Gaussian function is preferably equal to or more than 0.99. FIG. 7 shows the intensity distribution in the Y direction, but the same applies to the intensity distribution in the X direction.

In the embodiment, the diffusion target 27a having a Gaussian distribution shape is irradiated with the main pulse laser light 31m having the intensity distribution of a Gaussian distribution shape. Accordingly, since the center portion of the diffusion target 27a at which many target substances exist is irradiated with the center portion of the main pulse laser light 31m having a high intensity, it is considered that the energy of the main pulse laser light 31m is efficiently applied to the diffusion target 27a to turn into plasma. The determination coefficient R² of the distribution shape of the diffusion target 27a with respect to the Gaussian function is preferably equal to or more than 0.95.

In order to match the intensity distribution of the main pulse laser light 31m to the distribution of the target substance in the diffusion target 27a, it is desirable that the travel direction of the prepulse laser light 31p and the travel direction of the main pulse laser light 31m are close to each other as possible. The directional deviation of the optical path axes of the both is preferably equal to or less than 1°.

### 2.3 Intensity Ranges of Prepulse Laser Light 31p and Main Pulse Laser Light 31m

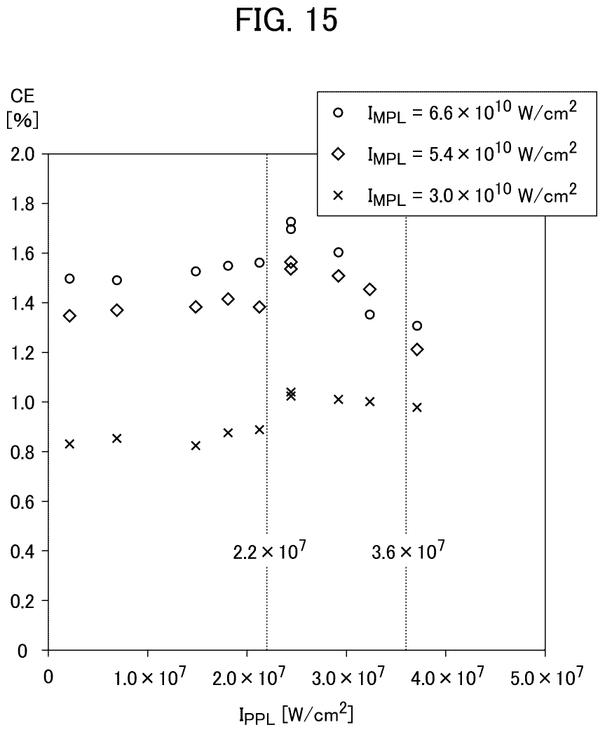

FIG. 15 is a graph showing the relationship between the conversion efficiency CE and the light intensities I_{PPL}, I_{MPL} of the prepulse laser light 31p and the main pulse laser light 31m. The horizontal axis of FIG. 15 represents the light intensity I_{PPL} of the prepulse laser light 31p, and the vertical axis represents the maximum conversion efficiency CE, that is, the conversion efficiency CE when the delay time DT is optimized under a given condition. In FIG. 15, three values are used as the light intensity I_{MPL} of the main pulse laser light 31m. The light intensity I_{MPL} of the main pulse laser light 31m is preferably equal to or more than 3.0×10¹⁰ W/cm² and equal to or less than 1.0×10¹¹ W/cm².

Data plotted on the rightmost side in FIG. 15 is data obtained when the light intensity I_{PPL} of the prepulse laser light 31p is the same as that of the comparative example, that is, 3.7×10⁷ W/cm². In this case, the conversion efficiency CE is not high enough.

On the other hand, when the light intensity I_{PPL} of the prepulse laser light 31p is less than 1.6×10⁷ W/cm², ablation of the target substance does not occur, and a good diffusion target 27a is not generated. Further, even when the light intensity I_{PPL} of the prepulse laser light 31p is equal to or more than 1.6×10⁷ W/cm² and equal to or less than 2.2×10⁷ W/cm², the conversion efficiency CE is not sufficiently high.

When the light intensity I_{PPL} of the prepulse laser light 31p is equal to or more than 2.2×10⁷ W/cm² and equal to or less than 3.6×10⁷ W/cm², the conversion efficiency CE is improved compared to the case in which the light intensity IPLP of the prepulse laser light 31p is set to 3.7×10⁷ W/cm², which is the same as that in the comparative example.

Compared to a case in which the light intensity I_{MPL} of the main pulse laser light 31m is 3.0×10¹⁰ W/cm², the conversion efficiency CE is further improved when the light intensity I_{MPL} of the main pulse laser light 31m is equal to or more than 5.4×10¹⁰ W/cm² and equal to or less than 6.6×10¹⁰ W/cm².

### 2.4 Intensity Distribution in Accordance with EUV Radiation Angle A_{EUV}

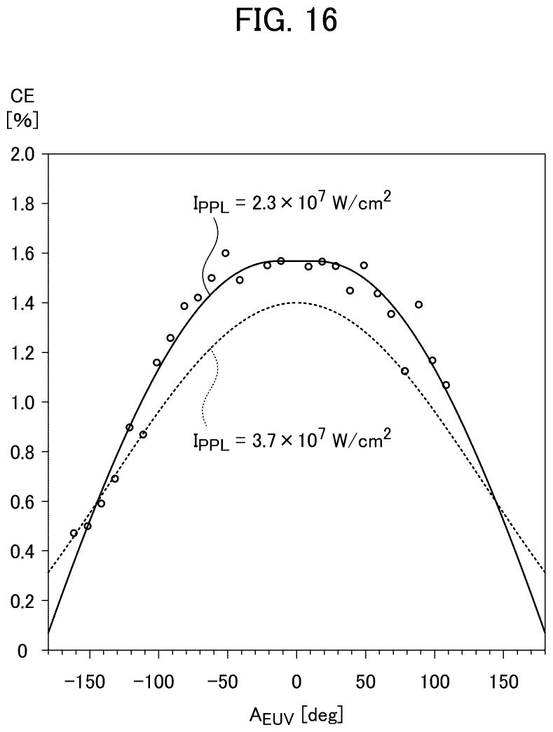

FIG. 16 is a graph showing the intensity distributions of the EUV light in the comparative example and the embodiment. In FIG. 16, the horizontal axis represents an EUV radiation angle A_{EUV} in which the direction opposite to the travel direction of the prepulse laser light 31p is assumed to be 0°, and the vertical axis represents the conversion efficiency CE of the EUV light at the respective radiation angles.

In the comparative example, that is, when the light intensity I_{PPL} of the prepulse laser light 31p is 3.7×10⁷ W/cm², the intensity of the EUV light is peaked in the direction of the EUV radiation angle A_{EUV}=0, and decreases as deviating from A_{EUV}=0°. Therefore, the range of A_{EUV} in which a practically sufficient intensity can be obtained is narrow.

On the other hand, in the embodiment, an intensity substantially equal to the peak intensity is obtained in the range of −50°<A_{EUV}<50°, and although the intensity decreases when deviating from the range, a practically sufficient intensity can be obtained even in the range of −100°<A_{EUV}<100°. According to the embodiment, not only the peak intensity of the EUV light is increased, but also a high intensity is obtained in a wide range of the EUV radiation angle A_{EUV}, so that the intensity of the EUV light concentrated by the EUV light concentrating mirror 23 is improved, and the degree of freedom in arrangement of the EUV light concentrating mirror 23 is improved.

In the comparative example, even when the center portion 27b (see FIG. 4) of the diffusion target 27a is turned into plasma and radiates the EUV light, the peripheral portion 27c is not sufficiently turned into plasma, and thus the EUV light is blocked by resonance absorption of the peripheral portion 27c as the absolute value of the EUV radiation angle A_{EUV} increases. This is presumed to be the reason why the range of A_{EUV} in which a practically sufficient intensity can be obtained in the comparative example is narrow.

As shown in FIG. 6, in the embodiment, since the distribution shape of the diffusion target 27a is similar to the intensity distribution of the main pulse laser light 31m and the target substance existing in the peripheral portion of the diffusion target 27a is less, almost the entire diffusion target 27a is gasified, and many portions thereof are turned into plasma. This is presumed to be the reason why the EUV light is widely radiated in the embodiment.

### 2.5 Residual Debris after Irradiation of Main Pulse Laser Light 31m

In both the comparative example and the embodiment, the presence or absence of residual debris after irradiating the diffusion target 27a with the main pulse laser light 31m was examined. Residual debris is a mist-like target substance that has not been gasified by the main pulse laser light 31m. To examine the presence or absence of residual debris, probe laser light was radiated to the periphery of the plasma generation region 25, 1 μs after the main pulse laser light 31m was radiated, and Mie scattered light due to residual debris was measured.

In the comparative example, residual debris moving at about 3 km/s from the plasma generation region 25 in the +Z direction was observed, but in the embodiment, residual debris was not observed. In the embodiment, it is considered that most of the diffusion target 27a was gasified and the mist-like target substance was reduced to an unobservable extent. According to the embodiment, there is an effect that contamination of optical components inside the chamber 2 such as the EUV light concentrating mirror 23 due to residual debris is suppressed.

### 2.6 Effect

(1) In the embodiment, the EUV light generation apparatus 1 includes the chamber 2, the target supply unit 26, the prepulse laser PPL, and the main pulse laser MPL. The target supply unit 26 supplies the target 27 into the chamber 2. The prepulse laser PPL irradiates the target 27 with the prepulse laser light 31p to generate the diffusion target 27a having a Gaussian distribution shape convex toward the travel direction of the prepulse laser light 31p. The main pulse laser MPL generates the EUV light by irradiating the diffusion target 27a with the main pulse laser light 31m having an intensity distribution of a Gaussian distribution shape. Accordingly, by causing the diffusion target 27a to have a Gaussian distribution shape, the energy of the main pulse laser light 31m having the intensity distribution of a Gaussian distribution shape can be efficiently applied to the diffusion target 27a, and the conversion efficiency CE can be improved.
(2) In the embodiment, the determination coefficient R² of the distribution shape of the diffusion target 27a with respect to the Gaussian function is equal to or more than 0.95. Accordingly, since the distribution shape of the diffusion target 27a is a shape close to the Gaussian distribution, the energy of the main pulse laser light 31m can be efficiently applied to many parts of the diffusion target 27a.
(3) In the embodiment, the light intensity I_{PPL} at the position at which the target 27 is irradiated with the prepulse laser light 31p is equal to or more than 2.2×10⁷ W/cm² and equal to or less than 3.6×10⁷ W/cm². Accordingly, the effect of improving the conversion efficiency CE can be obtained in combination with the main pulse laser light 31m having a wide intensity range.
(4) In the embodiment, the light intensity I_{MPL} at the position at which the diffusion target 27a is irradiated with the main pulse laser light 31m is equal to or more than 3.0×10¹⁰ W/cm² and equal to or less than 1.0×10¹¹ W/cm². Accordingly, the diffusion target 27a can be efficiently turned into plasma by the main pulse laser light 31m.
(5) In the embodiment, the light intensity I_{MPL} at the position at which the diffusion target 27a is irradiated with the main pulse laser light 31m is equal to or more than 5.4×10¹⁰ W/cm² and equal to or less than 6.6×10¹⁰ W/cm². Accordingly, high conversion efficiency CE can be obtained by adjusting the light intensity I_{MPL} of the main pulse laser light 31m.
(6) In the embodiment, the delay time DT from when the target 27 is irradiated with the prepulse laser light 31p to when the diffusion target 27a is irradiated with the main pulse laser light 31m is equal to or more than 100 ns and equal to or less than 400 ns. In the above delay time DT, the Gaussian distribution shape of the diffusion target 27a can be maintained, and thus the diffusion target 27a can be efficiently turned into plasma by the main pulse laser light 31m.
(7) In the embodiment, the delay time DT from when the target 27 is irradiated with the prepulse laser light 31p to when the diffusion target 27a is irradiated with the main pulse laser light 31m is equal to or more than 340 ns and equal to or less than 370 ns. Accordingly, the diffusion target 27a when the main pulse laser light 31m is radiated is not too large and too small, so that the diffusion target 27a can be efficiently turned into plasma.
(8) In the embodiment, the focus diameter of the main pulse laser light 31m is equal to or more than 30 μm and equal to or less than 100 μm. Accordingly, the diffusion target 27a can be efficiently turned into plasma by the main pulse laser light 31m.
(9) In the embodiment, the pulse width T_{PPL} of the prepulse laser light 31p is equal to or more than 60 ns and equal to or less than 100 ns, and the pulse width T_{MPL} of the main pulse laser light 31m is equal to or more than 10 ns and equal to or less than 30 ns. Accordingly, the target 27 can be ablated by the prepulse laser light 31p over time, and the diffusion target 27a having a Gaussian distribution shape can be obtained. Further, the diffusion target 27a can be efficiently turned into plasma by the main pulse laser light 31m.
(10) In the embodiment, the prepulse laser light 31p and the main pulse laser light 31m have the wavelength of 1 μm. Accordingly, the prepulse laser light 31p and the main pulse laser light 31m can be generated by a solid-state laser.

In other respects, the embodiment is similar to the comparative example.

### 3. Others

### 3.1 Examples of EUV Light Utilization Apparatus 6

FIG. 17 schematically shows the configuration of the exposure apparatus 6a connected to the EUV light generation system 11. The exposure apparatus 6a as the EUV light utilization apparatus 6 (see FIG. 1) includes a mask irradiation unit 608 and a workpiece irradiation unit 609. The mask irradiation unit 608 illuminates, via a reflection optical system, a mask pattern of a mask table MT with the EUV light incident from the EUV light generation system 11. The workpiece irradiation unit 609 images the EUV light reflected by the mask table MT onto a workpiece (not shown) arranged on a workpiece table WT via a reflection optical system. The workpiece is a photosensitive substrate such as a semiconductor wafer on which photoresist is applied. The exposure apparatus 6a synchronously translates the mask table MT and the workpiece table WT to expose the workpiece to the EUV light reflecting the mask pattern. Through the exposure process as described above, a device pattern is transferred onto the semiconductor wafer, thereby an electronic device can be manufactured.

FIG. 18 schematically shows the configuration of the inspection apparatus 6b connected to the EUV light generation system 11. The inspection apparatus 6b as the EUV light utilization apparatus 6 (see FIG. 1) includes an illumination optical system 603 and a detection optical system 606. The illumination optical system 603 reflects the EUV light incident from the EUV light generation system 11 to illuminate a mask 605 placed on a mask stage 604. Here, the mask 605 conceptually includes a mask blanks before a pattern is formed. The detection optical system 606 reflects the EUV light from the illuminated mask 605 and forms an image on a light receiving surface of a detector 607. The detector 607 having received the EUV light obtains the image of the mask 605. The detector 607 is, for example, a time delay integration (TDI) camera. A defect of the mask 605 is inspected based on the image of the mask 605 acquired by the above-described process, and a mask suitable for manufacturing an electronic device is selected using the inspection result. Then, the electronic device can be manufactured by exposing and transferring the pattern formed on the selected mask onto the photosensitive substrate using the exposure apparatus 6a.

### 3.2 Supplement

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that the embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of the any thereof and any other than A, B, and C.

What is claimed is:

1. An extreme ultraviolet light generation apparatus comprising:
a chamber;
a target supply unit configured to supply a target into the chamber;
a prepulse laser configured to generate a diffusion target having a Gaussian distribution shape convex toward a travel direction of prepulse laser light by irradiating the target with the prepulse laser light; and
a main pulse laser configured to generate extreme ultraviolet light by irradiating the diffusion target with main pulse laser light having an intensity distribution of a Gaussian distribution shape.

2. The extreme ultraviolet light generation apparatus according to claim 1,
wherein a determination coefficient of a distribution shape of the diffusion target with respect to a Gaussian function is equal to or more than 0.95.

3. The extreme ultraviolet light generation apparatus according to claim 1,
wherein a light intensity of the prepulse laser light at a position at which the target is irradiated with the prepulse laser light is equal to or more than 2.2×10⁷ W/cm² and equal to or less than 3.6×10⁷ W/cm².

4. The extreme ultraviolet light generation apparatus according to claim 3,
wherein a light intensity of the main pulse laser light at a position at which the diffusion target is irradiated with the main pulse laser light is equal to or more than 3.0×10¹⁰ W/cm² and equal to or less than 1.0×10¹¹ W/cm².

5. The extreme ultraviolet light generation apparatus according to claim 3,
wherein a light intensity of the main pulse laser light at a position at which the diffusion target is irradiated with the main pulse laser light is equal to or more than 5.4×10¹⁰ W/cm² and equal to or less than 6.6×10¹⁰ W/cm².

6. The extreme ultraviolet light generation apparatus according to claim 1,
wherein a delay time from when the target is irradiated with the prepulse laser light to when the diffusion target is irradiated with the main pulse laser light is equal to or more than 100 ns and equal to or less than 400 ns.

7. The extreme ultraviolet light generation apparatus according to claim 1,
wherein a delay time from when the target is irradiated with the prepulse laser light to when the diffusion target is irradiated with the main pulse laser light is equal to or more than 340 ns and equal to or less than 370 ns.

8. The extreme ultraviolet light generation apparatus according to claim 7,
wherein a focus diameter of the main pulse laser light is equal to or more than 30 μm and equal to or less than 100 μm.

9. The extreme ultraviolet light generation apparatus according to claim 1,
wherein a pulse width of the prepulse laser light is equal to or more than 60 ns and equal to or less than 100 ns, and a pulse width of the main pulse laser light is equal to or more than 10 ns and equal to or less than 30 ns.

10. The extreme ultraviolet light generation apparatus according to claim 1,
wherein the prepulse laser light and the main pulse laser light have a wavelength of 1 μm.

11. The extreme ultraviolet light generation apparatus according to claim 1,
wherein a directional deviation of optical path axes of the prepulse laser light and the main pulse laser light is equal to or less than 1°.

12. The extreme ultraviolet light generation apparatus according to claim 1,
wherein a travel direction of the prepulse laser light and a travel direction of the main pulse laser light is identical to each other.

13. An electronic device manufacturing method, comprising:
generating extreme ultraviolet light using an extreme ultraviolet light generation apparatus;
outputting the extreme ultraviolet light to an exposure apparatus; and
exposing a photosensitive substrate to the extreme ultraviolet light in the exposure apparatus to manufacture an electronic device,
the extreme ultraviolet light generation apparatus including:
a chamber;
a target supply unit configured to supply a target into the chamber;
a prepulse laser configured to generate a diffusion target having a Gaussian distribution shape convex toward a travel direction of prepulse laser light by irradiating the target with the prepulse laser light; and
a main pulse laser configured to generate the extreme ultraviolet light by irradiating the diffusion target with main pulse laser light having an intensity distribution of a Gaussian distribution shape.

14. The electronic device manufacturing method according to claim 13,
wherein a determination coefficient of a distribution shape of the diffusion target with respect to a Gaussian function is equal to or more than 0.95.

15. The electronic device manufacturing method according to claim 13,
wherein a light intensity of the prepulse laser light at a position at which the target is irradiated with the prepulse laser light is equal to or more than 2.2×10⁷ W/cm² and equal to or less than 3.6×10⁷ W/cm².

16. The electronic device manufacturing method according to claim 15,
wherein a light intensity of the main pulse laser light at a position at which the diffusion target is irradiated with the main pulse laser light is equal to or more than 3.0×10¹⁰ W/cm² and equal to or less than 1.0×10¹¹ W/cm².

17. An electronic device manufacturing method, comprising:
inspecting a defect of a mask by irradiating the mask with extreme ultraviolet light generated by an extreme ultraviolet light generation apparatus;
selecting a mask using a result of the inspection; and
exposing and transferring a pattern formed on the selected mask onto a photosensitive substrate,
the extreme ultraviolet light generation apparatus including:
a chamber;
a target supply unit configured to supply a target into the chamber;
a prepulse laser configured to generate a diffusion target having a Gaussian distribution shape convex toward a travel direction of prepulse laser light by irradiating the target with the prepulse laser light; and
a main pulse laser configured to generate the extreme ultraviolet light by irradiating the diffusion target with main pulse laser light having an intensity distribution of a Gaussian distribution shape.

18. The electronic device manufacturing method according to claim 17,
wherein a determination coefficient of a distribution shape of the diffusion target with respect to a Gaussian function is equal to or more than 0.95.

19. The electronic device manufacturing method according to claim 17,
wherein a light intensity of the prepulse laser light at a position at which the target is irradiated with the prepulse laser light is equal to or more than 2.2×10⁷ W/cm² and equal to or less than 3.6×10⁷ W/cm².

20. The electronic device manufacturing method according to claim 19,
wherein a light intensity of the main pulse laser light at a position at which the diffusion target is irradiated with the main pulse laser light is equal to or more than 3.0×10¹⁰ W/cm² and equal to or less than 1.0×10¹¹ W/cm².
